(19) United States
(12) Patent Application Publication
(10) Pub. No.: US 2024/0001964 A1
(43) Pub. Date: Jan. 4, 2024

(54) SAFE AGILE HAZARD AVOIDANCE SYSTEM FOR AUTONOMOUS VEHICLES

(71) Applicant: RUTGERS, THE STATE UNIVERSITY OF NEW JERSEY, New Brunswick, NJ (US)

(72) Inventors: Aliasghar Arab, Piscataway, NJ (US); Jingang Yi, Piscataway, NJ (US)

(21) Appl. No.: 18/209,943

(22) Filed: Jun. 14, 2023

Related U.S. Application Data
(60) Provisional application No. 63/356,879, filed on Jun. 29, 2022.

(51) Int. Cl. B60W 60/00; B60W 30/18; B60W 40/06

(52) U.S. Cl. CPC B60W 60/0015; B60W 30/18009; B60W 40/06

(57) ABSTRACT

Techniques disclosed herein relate to applying a trained constrained Markov decision process (CMDP) to control an autonomous vehicle to perform a stunt maneuver, such as a J-turn, in a safe and agile manner. The CMDP may implement a set of fuzzy logic instructions that correspond to actions needed to execute the stunt maneuver. While training the CMDP, the techniques disclosed herein may utilize a dynamic model of the autonomous vehicle that includes a model of the uncertainty introduced when implementing the stunt maneuver, such as the uncertainty in the tire-road mechanics. By utilizing a worst case scenario measure of the uncertainty during training, safe performance of the stunt maneuver is guaranteed when the trained model is applied in the real world.

### CROSS-REFERENCE TO RELATED APPLICATIONS

This application claims priority to and the benefit of U.S. Application No. 63/356,979 filed Jun. 29, 2022, the entire disclosure of which is hereby incorporated by reference.

### STATEMENT REGARDING FEDERALLY SPONSORED RESEARCH OR DEVELOPMENT

This invention was made with government support under contract No. CNS-1932370 awarded by the United States National Science Foundation (NSF). The government has certain rights in the invention.

### FIELD OF THE DISCLOSURE

The present disclosure generally relates to control systems of autonomous vehicle and, more specifically, to a controlling an autonomous vehicle to execute a stunt maneuver in a safe and agile manner.

### BACKGROUND

Extreme driving maneuvers performed by professional car drivers can be potentially used as active safety features for passenger vehicles under emergency situations. Control design of these extreme driving strategies is challenging since these extreme driving operations usually occur at the maximum limit of the vehicle's maneuverability. In recent years, reinforcement Learning (RL) is used for control design of aggressive maneuvering for aerial and ground vehicles. Safe RL attracts attention in recent years for control systems design and natural language can be used to add safety conditions to the policy search algorithms. Safe reinforcement learning provides an enabling tool to design feasible and safe extreme maneuvers for future autonomous vehicles.

Random exploration for a specific control policy is highly inefficient and might completely fail. It is viable and desirable to incorporate expert instructions and suggestions with policy search algorithms to find a rewarding policy with fewer learning iterations. It is shown that a good advice can reduce the amount of exploration required to learn a control policy. Human's advice can be converted into synthetic training experiences to scaffold the basic representations of RL. External knowledge can initialize a policy search to avoid unnecessary random exploration. However, the instructed RL control policy search might perform well in simulations but poorly in real world practice, and therefore the safety of control policy is not ensured.

To address the above-mentioned problem of the safe control policy search, various methods have been developed to integrate safety features into policy learning. The safe learning algorithm developed is subjected to inequality and equality constraints to find a control policy under model uncertainty. In some frameworks, the safety of the RL-based control is guaranteed by constructing Lyapunov functions. Similarly, control barrier functions are used to guarantee safety with high probability during the learning process. A reinforcement learning framework combines the different simulation levels for steady-state drifting of a car without considering the safety criteria. A similar RL framework with multiple simulators of a target task with varying levels of fidelity is tested on a remote-controlled car. However, vehicle behavior during extreme maneuvers is highly un-predictive, and without understanding the vehicle dynamics, it is difficult to find and develop a safe control policy for these maneuvers.

Additional challenges need to be overcome to design autonomous extreme maneuvers such as J-turn, among which most notably the unstable nature of maneuvering motion, the uncertainties in analytical models, and unpredictability of the performance in a new environment. A small variation such as the road-tire interaction property can significantly change the behavior of the vehicle dynamics for agile maneuvers. Analytical methods have been successfully used to design a particular autonomous extreme maneuver but it is difficult to be generalized for other maneuvers. Most of state-of-the-art works in vehicle control focus on normal maneuvers and analytical models show good agreement in simulation and real world application. However, model-based reinforcement learning requires a precise analytical model to simulate and design a control policy for extreme maneuvers. The safety of these control policies in real-world implementation can only be guaranteed for the Worst-Case (WC) situations by knowledge of the uncertainty range.

In view of the foregoing challenges, there is a need for an instructed learning method to find safe stunt vehicle maneuvers (such as a J-turn) with tire model uncertainties.

### SUMMARY

In an embodiment, a computer-implemented method for safe stunt maneuvering of an autonomous vehicle is provided. The method includes (1) detecting, by one or more processors, a stimulus to initiate a stunt maneuver; (2) inputting, by the one or more processors, a state of the autonomous vehicle into a constrained Markov decision processing (CMDP) model configured to output an action sequence to control the autonomous vehicle to perform the stunt maneuver, wherein the CMDP model is trained by (a) obtaining a set of fuzzy instructions that indicate a set of actions that, when executed by an autonomous vehicle, implement the stunt maneuver, (b) obtaining a dynamic model for the autonomous vehicle, and (c) performing, using the dynamic model, a plurality of simulations of the stunt maneuver using the fuzzy instructions, wherein the CMDP rewards simulations that result in successful performance of the stunt maneuver, and (3) applying, by the one or more processors, the action sequence to autonomous vehicle control systems to cause the autonomous vehicle to perform the stunt maneuver.

A non-transitory computer-readable storage medium is provided. The computer-readable storage medium is configured to store processor-executable instructions for safe stunt maneuvering of an autonomous vehicle that, when executed by one or more processors, cause the one or more processors to (1) detect a stimulus to initiate a stunt maneuver; (2) input a state of the autonomous vehicle into a constrained Markov decision processing (CMDP) model configured to output an action sequence to control the autonomous vehicle to perform the stunt maneuver, wherein the CMDP model is trained by (a) obtaining a set of fuzzy instructions that indicate a set of actions that, when executed by an autonomous vehicle, implement the stunt maneuver, (b) obtaining a dynamic model for the autonomous vehicle, (c) performing, using the dynamic model, a plurality of simulations of the stunt maneuver using the fuzzy instructions, wherein the CMDP rewards simulations that result in successful performance of the stunt maneuver; and (3) apply the action sequence to autonomous vehicle control systems to cause the autonomous vehicle to perform the stunt maneuver.

### BRIEF DESCRIPTION OF THE DRAWINGS

It is believed that the disclosure will be more fully understood from the following description taken in conjunction with the accompanying drawings. Some of the drawings may have been simplified by the omission of selected elements for the purpose of more clearly showing other elements. Such omissions of elements in some drawings are not necessarily indicative of the presence or absence of particular elements in any of the example embodiments, except as may be explicitly delineated in the corresponding written description. Also, none of the drawings is necessarily to scale.

FIG. 1 depicts an example control system for an autonomous vehicle in which the autonomous stunt maneuvering techniques disclosed herein are implemented.

FIG. 2 depicts an example embedded computing system configured to implement the autonomous stunt maneuvering techniques disclosed herein.

FIG. 3 depicts an example stunt maneuver and its representation as a set of fuzzy instructions.

FIGS. 4A, 4B and 4C depict a bounded friction model for dynamic tire-surface interactions.

FIG. 5 depicts an example method for safe stunt maneuver of an autonomous vehicle, in accordance with techniques disclosed herein.

### DETAILED DESCRIPTION

Techniques disclosed herein relate to a sequential learning approach for performing a stunt maneuver is a safe and agile manner. It should be appreciated that the examples disclosed herein detail an implementation of a stunt J-turn when a vehicle moving reverse performs a full 180-degree turn to drive forwards in the same direction of travel, the sequential learning approach can be readily applied to other stunt maneuvers that are modeled using non-ideal nonholonomic constraints due to presence of tire slipping and/or skidding during execution of the stunt maneuver. By building a library of stunt maneuvers that can be performed in a safe and agile manner, a hazard avoidance system of an autonomous vehicle can evaluate a plurality of stunt maneuvers to identify a particular stunt maneuver that can safely avoid the hazard and/or minimize damage caused by the hazard.

It should be appreciated that the term “autonomous vehicle” is not restricted to fully autonomous vehicles. That is, the autonomous stunt maneuvering techniques may be implemented in a semi-autonomous vehicle that executes the stunt maneuver autonomously in response to detecting the hazard and/or a manual input to initiate the stunt maneuver.

### System Overview

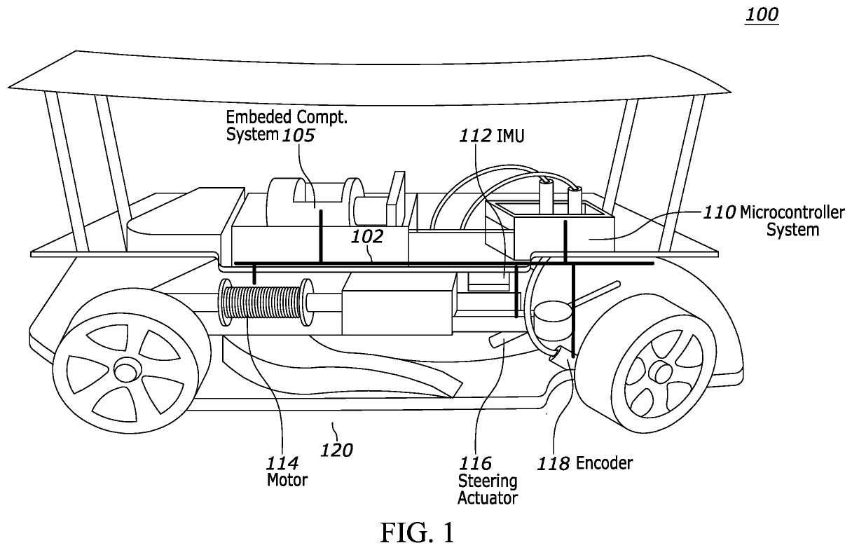

FIG. 1 depicts an example control system 100 for an autonomous vehicle 120 in which the autonomous stunt maneuvering techniques disclosed herein are implemented. As illustrated, the example control system 100 includes an embedded computing system 105 such which includes one or more processors adapted to autonomously control the autonomous vehicle 120. Accordingly, the embedded computing system 105 may be communicatively coupled to a plurality of vehicle sensors and/or components to obtain information regarding the state of the autonomous vehicle 120. For example, the embedded computing system 105 may be coupled to an inertial measurement unit 112 to obtain acceleration data (including rotational acceleration data), a motor 114 to obtain a vehicle speed, a steering actuator 116 to obtain an angle of rotation for one or more steerable wheel, and an encoder 118 to obtain sensor data (e.g., image data, radar data, LI DAR data) indicative of a path of travel in front of and/or behind the autonomous vehicle.

As will be described below, the embedded computing system 105 may input the received sensor data into a decision making model to determine a set of autonomous vehicle control actions to control the autonomous vehicle 120. The embedded computing system 105 may then route the control actions to a microcontroller 105 for implementation thereof. In one example, a control instruction is to increase the speed the of the autonomous vehicle 120. Accordingly, the microcontroller 105 may instruct the motor 114 to increase its speed. In another example, a control instruction is to turn the autonomous vehicle 120 to the right. Accordingly, the microprocessor 105 may control the steering actuator 116 to rotate the wheels axially to the right. In alternate embodiments, the functionality of microcontroller 110 is implemented at the embedded computing system 105.

As illustrated, the components of the control system 100 are interconnected via a bus 102. Accordingly, the embedded computing system 105 may receive sensor data via the bus 102 and the microcontroller 110 may output control instructions to the components over the bus 102. In other embodiments, the bus 102 is divided into subnetworks to reduce message traffic. For example, the components of the autonomous vehicle 120 may be configured to output sensor data to a first subnetwork and issue control instructions over a second subnetwork.

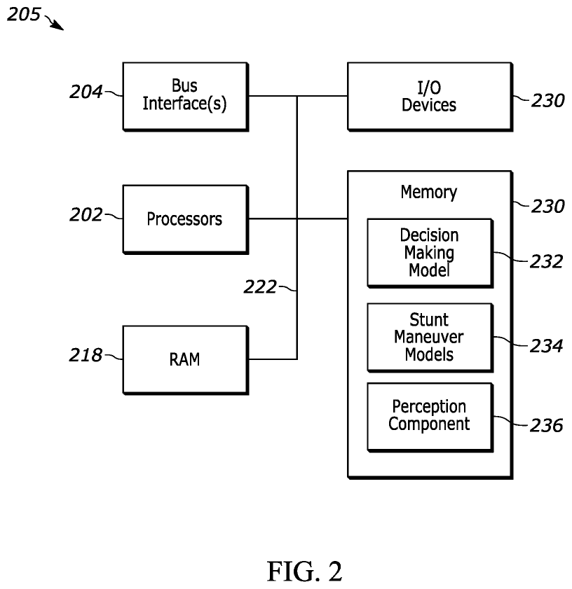

Turning to FIG. 2, illustrated is an example embedded computing system 205, such as the embedded computing system 105 of FIG. 1, at which functionality described herein is implemented. It should be understood that the example embedded computing system 205 is one example embedded computing system and that alternate embedded computing systems may include additional, fewer, and/or alternative components. The embedded computing system 205 includes one or more processors 202, such as a central processing unit (CPU) and/or a graphics processing unit (GPU). During operation, the processors 202 executes instructions stored in a memory module 230 coupled to the processors 202 via a system bus 222. In some implementations, the memory module 230 is as random access memory (RAM), a persistent memory, or combination of both.

As illustrated, the embedded computing system 205 includes bus interface(s) 204 via which the embedded computing system 205 interfaces with other components of an autonomous vehicle, such as the autonomous vehicle 120 of FIG. 1. For example, the bus interfaces 204 may include a controller area network (CAN) bus interface via which the embedded computing system 205 obtain sensors data from autonomous vehicle components. As another example, the bus interfaces 204 may include an Ethernet or other bus interface via which the embedded computing system 205 issues control instructions to other components of the autonomous vehicle (e.g., a steering actuator).

The memory module 230 may also store computer-readable instructions that regulate the operation of the autonomous vehicle. One set of instructions may be a perception component 236 configured to analyze sensor data generated by autonomous vehicle sensors to determine a state of the vehicle. For example, the perception component 236 may be configured to identify one or more hazards along a direction of travel and/or a safe zone for safe operation of the autonomous vehicle. Another set of instructions may be a decision making model 232 configured to accept the state information from the perception component 236 to determine one or more autonomous control actions to perform. For example, the decision making model 232 may analyze the state information to identify that a particular stunt maneuver is to be performed to avoid a hazard and/or mitigate damage caused by the hazard. The decision making model may be implement as a Model Predictive Controller (MPC), a Nonlinear Model Predictive Controller (NM PC), and/or other types of predictive control decision making models. It should be appreciated that the while the instant disclosure is focused on decision making capabilities with respect to stunt maneuvering to avoid hazards, the decision making model 232 may also be configured to perform routine autonomous control decision making in accordance with other techniques known in the art.

The memory 230 also includes stunt maneuver models 234 respectively configured to output a set of actions that cause the autonomous vehicle to implement the corresponding stunt maneuver. As will be explained in more detail below, the stunt maneuver models 234 may be constrained Markov decision processes (CMDPs) trained using instructed reinforcement learning techniques (also referred to as IRL-CMDP). Accordingly, in response to the decision making model 232 deciding that a particular stunt maneuver is to be implemented, the decision making model 232 may input the state information to the stunt maneuver model 234 to produce the set of output actions. In some embodiments, the stunt maneuver model 234 writes the output actions to the bus interfaces 204 directly. In other embodiments, the decision making model 232 may process the output actions to ensure safe operation, identify any supplementary actions, and/or perform other processing prior to writing to the bus interface 204.

Additionally, the embedded computing system 205 includes one or more I/O deices via which the embedded computing system 205 interfaces with external devices. For example, the I/O device may include a universal serial bus (USB) port, a serial port, an Ethernet port, a wireless communication transceiver, etc. As will be explained below, the stunt maneuver models 234 may be partially trained via simulation software executed on an external workstation. Accordingly, the partially-trained models may be downloaded into the memory 230 via the I/O devices 208. As another example, the decision making model 232 may implement different logic depending upon the jurisdiction in which the autonomous vehicle is located. Accordingly, the embedded computing system 205 may receive an indication of a current jurisdiction via the I/O device 208.

### Development of Stunt Maneuver Models

To begin the process of developing a stunt maneuver model, the system first receives a set of instructions that describe the general process for performing the stunt maneuver. It should be appreciated that the system via which the stunt maneuver model is initially defined and trained may be a computing system external (e.g., a workstation computer) to the autonomous vehicle in which the control techniques will be actually implemented. In some embodiments, the instructions are defined in consultation with an expert at performing the stunt maneuver to have a baseline set of instructions that more accurately reflects the vehicle control actions needed to perform the intended stunt maneuver. Due to the extreme forces that act upon the autonomous vehicle while executing the stunt maneuver, it is difficult, if not impossible, to pre-program precise instructions that will consistently result in the performance of the stunt maneuver. Instead, the set of instructions are processed as a set of fuzzy instructions or fuzzy logic to be optimized and/or constrained via a CMDP process.

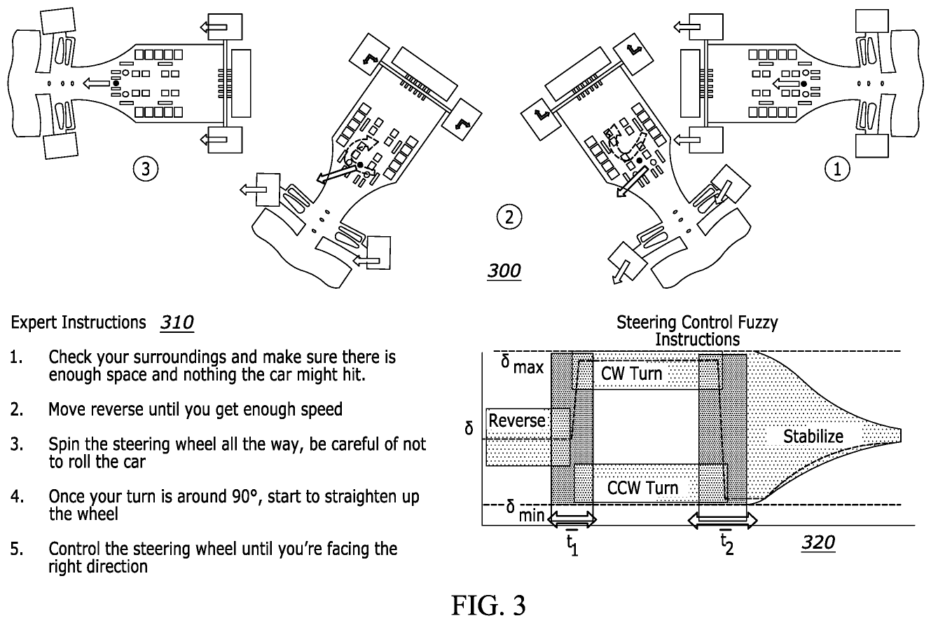

FIG. 3 depicts an example stunt maneuver and its representation as a set of fuzzy instructions. More particularly, FIG. 3 depicts a representation of a J-turn stunt maneuver 300. It should be appreciated that similar techniques may be applied to derive a set of fuzzy instructions for other types of stunt maneuvers.

As illustrated, the J-turn maneuver 300 is executed in three phases. First, the autonomous vehicle moves in a reverse direction. That is, in the representation depicted by FIG. 3, the autonomous vehicle is moving in reverse towards the left. Second, the autonomous vehicle performs a full 180° rotation such that the front of the autonomous vehicle is now pointing along the direction of travel. Third, the autonomous vehicle drives forward along the same direction of travel.

This process is then broken down into a set of expert instructions 310 that represent the J-turn maneuver. As illustrated, the set of expert instructions 310 includes five component instructions: 1) Check your surroundings and make sure there is enough space and nothing the car might hit; 2) Move reverse until you get enough speed; 3) Spin the steering wheel all the way, be careful of not to roll the car; 4) Once your turn is around 90°, start to straighten up the wheel; and 5) Control the steering wheel until you're facing the right direction.

The set of expert instructions 310 are then converted into the fuzzy instructions for control of the autonomous vehicle control system. For example, the graph 320 depicts a set of fuzzy instructions for control of a steering actuator when performing the J-turn maneuver. In particular, the graph 320 shows the displacement of a steering actuator over the time in which the J-turn maneuver 300 is performed. As illustrated, the J-turn maneuver 300 begins with the autonomous vehicle moving in reverse in a straight line. During a first fuzzy time window t1, the steering actuator is set to a maximum displacement in a first direction. Then, during a second fuzzy time window t2, the steering actuator is set to a minimum displacement. Afterwards, the steering actuator is controlled back to a neutral position such that the autonomous vehicle ends up moving forwards in a straight direction.

In the illustrated scenario, during the first fuzzy time window t1, the maximum displacement corresponds to a clockwise turn. In another scenario, the steering actuator is set to a minimum displacement corresponding to a counterclockwise turn during the fuzzy time window t1. It should be appreciated that the decision in setting the steering actuator may be based upon a proximity of the autonomous vehicle to a border of a safe zone and/or a location of a hazard. In other embodiments, to better model the lack of uniformity in tire performance, the system may train a separate model for clockwise and counterclockwise J-turn maneuvers.

The expert instructions 310 may also be converted into fuzzy instructions for control over other components of the vehicle. For example, the system may generate a fuzzy instruction representative of a time window to switch gears from reverse to a forwards gear (e.g., first gear, second gear, etc.). As another example, the system may generate fuzzy logic that indicates timing for throttle and/or brake controls.

In addition to the fuzzy logic that describes the stunt maneuver, the control policy that performs the stunt maneuver model also analyzes a model that represents the autonomous vehicle dynamics. In particular, tire-road interaction model plays a critical role in vehicle dynamics, particular for extreme maneuvers. Unfortunately, the tire force dynamics are commonly uncertain and difficult to measure in real time. This is particularly the case during extreme maneuvers when the tire-road model is highly nonlinear and transient dynamics are difficult to capture precisely. However, if the tire-road model accounts for the worst case scenario in modeling this uncertainty, then the model still will provide a safe response even if the response is less than predicted. As a result, the dynamic model of the autonomous vehicle accounts for the worst case scenario in developing the model and performing simulations thereof.

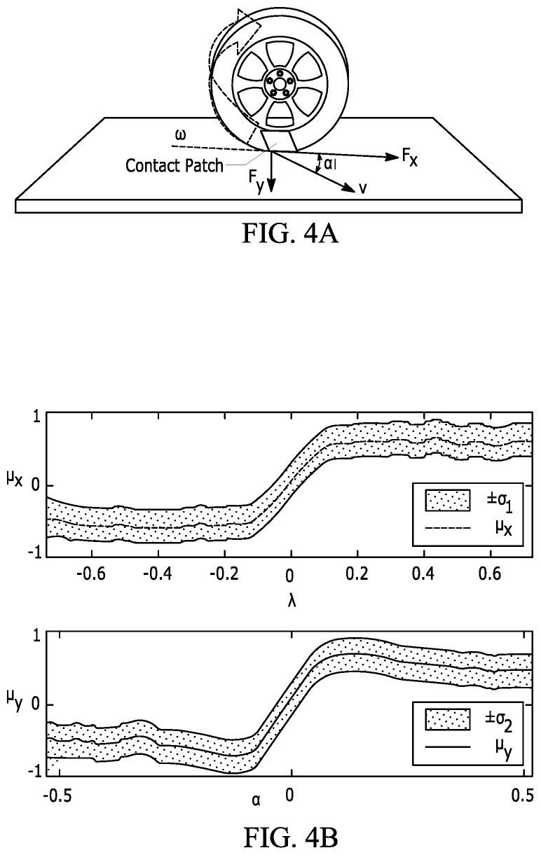

One way to identify the upper limit of model is to use the boundedness nature of a tire friction model. For example, as shown in FIG. 4C, a frictional circle is commonly used to describe the tire-road interaction forces, that is, \sqrt{Fₓ²+F_{xy}²}≤F_{z}μₜ where Fₓ, F_{y}, and F_{z} are the longitudinal, lateral and normal forces, respectively, and μ is the total friction coefficient. Knowledge of the upper- and lower-limit, denoted as H and L, of the friction models (see FIG. 4B), can be utilized to find a control policy for a J-turn by assuring the safety with an unknown friction model.

While the foregoing describes how to model uncertainty in the friction model, other uncertainties and forces caused by non-ideal constraints can also be modeled in a bounded manner. For example, the overall limits on accelerations and forces can be used to calculate a worst case scenario within these limits for safety checks.

In a closed-loop control system of an autonomous vehicle, the dynamic model of the autonomous vehicle includes models of the magnitude of the tire/road forces acting to accelerate, decelerate and rotate the vehicle bounded by {∥F_{x,y,z}(t)∥<F_{x,y,z}_{ₘₐₓ}∀t>0}. Additionally, torques and speed of the electric motor are bounded by {∥τₘ(t)∥<τ_{,m}_{ₘₐₓ}, ∥ωₘ(t)∥<ω_{,m}_{ₘₐₓ}, ∀t>0} and steering wheel rotation is bounded by δ(t)∈[δₘᵢₙ,δₘₐₓ]. The tire-road friction model is highly nonlinear and uncertain but limited where μ(t)∈[μₘᵢₙ,μₘₐₓ]. Knowing the maximum and minimum capability of the vehicle's actuators and range of model uncertainties, the dynamic model can predict a full range of states the autonomous vehicle can reach.

For example, z is the vector of the vehicle states, z=[q^{T} v^{T} ω^{T}]^{T}, where the vehicle pose is denoted as q=[x y φ]^{T}, the velocity vector is v=[vₓ v_{y} φ]^{T}, and the wheel's velocity vector is ω=[ω_{fl} ω_{fr} ωᵣₗ ωᵣᵣ]^{T} where first and second subscripts represent front (rear) and left (right) wheels. Accordingly, a discrete state space representation of the nominal vehicle dynamics is given as

zₜ₊₁=fₙ(zₜ,uₜ)+fᵤ(zₜ,uₜ)

where control inputs vector u=[(δζ]^{T}, where δ is the steering angle and ζ is the throttle rate, fᵤ is the uncertainty in the model and fₙ is the nominal part of the model represented as

$$\\ {f}_{n} ( {z}_{t} , {u}_{t} ) = [ \begin{matrix}{z}_{2} \\ {M}^{- 1} ( {B}_{x} {F}_{x} + {B}_{y} {F}_{y} - C \\ {K}_{ζ} ζ - {K}_{m} ( ω + {r}_{w} {F}_{x} )\end{matrix} ]$$

where the detail of the model matrices are described in A. Arab and J. Yi, “Safety-guaranteed learning-predictive control for aggressive autonomous vehicle maneuvers,” in Proc. IEEE/ASME Int. Conf. Adv. Intelli. Mechatronics. Virtual: IEEE, 2020, pp. 1036-1041, the disclosure of which is hereby incorporated by reference. Tire forces Fₓ and F_{y} are controlled implicitly using the steering wheel δ and throttle ζ. Using a Gaussian Process (GP), the upper and lower bound of the tire model uncertainty μ_{L} and μ_{H} can be for safety assurance during a policy search of the CMDP.

After defining the nominal model and the uncertainty model, the systems then apply reinforcement learning (RL) in a safe manner to train the CMDP model for the stunt maneuver. In particular, the safe RL procedure involves two decisionmaking scenarios: choosing the control sequence and action signals which are used by the controllers.

To begin, the system starts with representing the CMDP as a tuple of T={ [symbol] , [symbol] , uₜ, fₙ, fᵤ, P, r, γ, [symbol] , [symbol] }, where [symbol] is a finite set of vehicle states zₜ defined above, [symbol] is a hybrid set of continuous and discrete actions which result in the performance of the stunt maneuver, the inputs vectors uₜ, fₙ: [symbol] ×A→ [symbol] is the nominal dynamics model of the system, fᵤ: [symbol] → [symbol] is a bounded function for approximation of the uncertainty in the system dynamics, [symbol] is a set of unsafe states, r(z, a): [symbol] ×A→ [symbol] is the rewards function, γ∈(0,1) is a discount factor, P (zₜ₊₁|zₜ, aₜ): [symbol] ×A× [symbol] →[0,1] denotes the probability distribution function for the transition kernel, [symbol] : [symbol] ×A→ [symbol] where c(z,a) is the intermediate risk for state z with action sₐ. In this model, it is assumed that the set of unsafe states is initially empty.

A policy it π: [symbol] → [symbol] ( [symbol] ) maps each state to a probability distribution over the possible actions associated with the CMDP. The value of a state z under policy it is denoted V^{π,P}( [symbol] ) and represents the expected sum of discounted returns when stating from an initial state and executing policy π.

$$\\ {V}^{π , P} ( 𝓏 ) = {𝔼}^{{V}^{π , P}} [ {\sum }_{t = 0}^{∞} {γ}^{t} r ( {𝓏}_{t} , {a}_{t} \vert {𝓏}_{0} = 𝓏 ]$$

where the value function V^{π,P(z) for policy π relates to an action-value function for the expected discounted return according to policy π when choosing action a in state z as}

V^{π,P}(z)= [symbol] ^{V}^{^{π,P}}[Q^{π}(z,a)]

in which both of the value function and the action-value function satisfy the recursive expression

Q(zₜ,aₜ)= [symbol] _{z}_{ₜ₊₁}_{|z}_{ₜ}_{,a}_{ₜ}[r(zₜ,aₜ)+γV(zₜ₊₁)]

At each state, the CDMP moves to the next if the next state is safe. That said, a state will still move to the set of unsafe states if the safety penalty cost violates the upper bound of the uncertainty criteria ∥c(z,a)∥_{inf}>σ, where the upper bound of safety criteria is a limited positive value σ(z, t)∈ [symbol] ≥0. As is it is generally used herein “safe” refers to a constrained policy optimization that results in an optimal policy within the subset of safe states.

When performing the optimization process, the policy that implements a stunt maneuver may be considered a hybrid policy of a simple class in which the action spaces are represented with both continuous and discrete dimensions. Accordingly, a generalized state dependent distribution of action policy models π(a|z) both discrete and continuous random variables is modeled as

$$\\ π ( a \vert 𝓏 ) = {π}^{Ϛ} ( {a}^{Ϛ} \vert 𝓏 ) {π}^{d} ( {a}^{D} \vert 𝓏 ) = {\prod }_{{a}^{i} ∈ {a}^{Ϛ}} {π}^{Ϛ} ( {a}^{i} \vert 𝓏 ) {\prod }_{{a}^{i} ∈ {a}^{D}} {π}^{d} ( {a}^{i} \vert 𝓏 )$$

where ζ and D represent the continuous and sequential discrete action spaces.

Returning to the J-turn example, there are 3 discrete actions to perform the J-turn: (1) the first switching window where the steering actuator is set to a maximum displacement, (2) the second switching window where the steering actuator is set to the minimum displacement; and (3) the stabilization to align with the direction of travel. Accordingly, for the CMDP corresponding to the J-turn, K=3 discrete choices of action sequences. It should be appreciated that other stunt maneuvers may require a different number of discrete choices to implement the corresponding action sequences. Regardless, each of the discrete choices may have corresponding continuous actions represented as a normal distribution of continuous values represented as uₖ∈Uₖ.

As described above, the optimization techniques described herein are optimized using a worst case scenario assumption. As a result, instead of maximizing the expectation of the return for the worst case policy over all possible models, the worst case scenario of all safety functions should be limited to the upper bound of uncertainty criteria. Accordingly, the problem solved by the CMDP can be stated as

max_{π} [symbol] ^{π,P}[Σₜ₌₀^{∞}γ^{t}r(zₜ,μ^{π}(zₜ))|z₀∈ [symbol] ′]

s.t. min_{σ}∥c(zₜ,aₜ)∥_{inf}<ϵₜ^{safe},∀t∈[0,T]

where [symbol] ^{π,P}(⋅) stands for the rewards with respect to the policy π and the transition model P. In some embodiments, the maximum safety penalty cost associated to the worst case scenario is limited to the upper bound of safety criteria ϵₜ^{safe}. Based on the limits of the uncertainty in the dynamic model of the autonomous vehicle, the CMDP can predict all of the reachable states zₜ₊₁ for each of the discrete actions that implement the stunt maneuver.

An example algorithm that guarantees safety using the CMDP developed in accordance with the instant techniques is provided below:

Algorithm 1: Safe IRL-ASVM initialized
by a sequence of fuzzy instructions

| 1 | Initialize RL Policy using the instructions πₛᵢₘ⁰; | | |
|---|---|---|---|
| 2 | Initialize the nominal model | | |
| 3 | Learn the policy for fₙ as πₛᵢₘ^{f} using πₛᵢₘ⁰; | | |
| 4 | Collect episode rewards; | | |
| 5 | Start: Safe RL search with πₛᵢₘ^{f} while safe policy for | | |
| | RW is not found do | | |
| 6 | \| | Evolve the policy search through CMDP in | |
| | \| | simulations; | |
| 7 | \| | Evaluate safey criterias for WC scenarios; | |
| | \| | if Policy is safe then | |
| 8 | \| | \| | Update the policy π_{rw} for RW experiments |

| | | |
|---|---|---|
| | \| | end |
| 9 | \| | i ← i + 1; |

| | |
|---|---|
| | end |
| 10 | Initialize the controller for the RW; |

In the example algorithm, the initial control policy πₛ^{init} is based on the nominal model fₙ(⋅) when the optimal controller is designed for a nominal system. By performing the simulations, the safe control policy is explored without violating safety criteria for the worst case scenario in the uncertainty model fᵤ(⋅).

To perform the simulations, the CMDP framework and the dynamic autonomous vehicle model may be provided to a simulation environment. One such simulation environment is the CARLA open-source autonomous vehicle simulator. Accordingly, the simulations performed in accordance with Algorithm 1 may be executed by a workstation computer executing the CARLA simulator prior to implementation at an embedded computing system of an autonomous vehicle. That is, as indicated by step (7), only when the policy is first determined to be safe for real world (RW) experiments, the CMDP is then downloaded into the embedded computing system for further refinement thereat.

Regardless of whether the training is conducted in the simulation environment or in the real world, the reward function for a given episode of the J-turn stunt maneuver may be characterized as

$$\\ r = - {\sum }_{k = 1}^{3} {\sum }_{t = {\dot{t}}_{k - 1}}^{{\dot{t}}_{k}} [ Δ {K}_{t} - {( {φ}_{t} - {φ}_{d , {\dot{t}}_{k}} )}^{2} ]$$

where the first term in the reward optimizes based upon the kinetic energy lost by the autonomous vehicle while performing the stunt maneuver, and the second term in the reward optimizes based upon an error between the expected autonomous vehicle orientation and the actual autonomous vehicle orientation for each sequence in the episode. As described above, the J-turn maneuver includes three discrete sequences per episode, as indicated by the upper limit on k being 3. For other types of stunt maneuvers, the upper limit on k may vary based on the number of discrete sequences required to perform the alternate stunt maneuver.

To find the desired control police, the CMDP computes the sequence of input commands and predicted trajectory of states using numerical simulations. The learned safe control policy and NM PC are embedded into the autonomous vehicle (e.g., as the stunt maneuver model 234 and decision making model 232, respectively).

When the CMDP is used in conjunction with an NM PC, the hybrid policy search techniques disclosed above prevent the vehicle from entering the unsafe sub-set of state space for the future prediction horizon Hp, {sₜ^{k}∉D∀t>0, k=1, . . . , Hₚ}. Moreover, unlike techniques that rely upon traditional RL to solve the CMDP, such as those that use a control barrier function (CBF), the NM PC is able to solve the convex constrained optimizations approximately in real-time to provide minimal control deviation from the safe control policy. This enables the instant techniques to avoid or mitigate damage by performing advanced stunt maneuvering techniques in a manner that is not conventionally possible. This is particularly advantageous where the maneuver places significant strain on the tire-road relationship such that there is uncertainty in the expected autonomous vehicle dynamic model.

For example, the below table compares the performance of a Safe IRL model, a conventional RL-CBF model, and the disclosed safe IRL-NMPC model for a J-turn stunt maneuver:

TABLE 1

| Method | WC scenario | RW | J-turn time |
|---|---|---|---|
| Safe IRL | 96.00% | 87.50% | 1.72 ms |
| RL-CBF [11] | 96.00% | 75.00% | 1.82 ms |
| Safe IRL-NMPC | 100.00% | 100.00% | 1.51 ms |

As shown in Table 1, the disclosed Sage IRL-NMPC techniques are able to remain with the safety constraints 100% of the time in both the worst case scenario and in the real world, while also being able to perform the J-turn maneuver faster.

### Automated Application of Stunt Maneuvering

As described above, an autonomous vehicle may have multiple CMDPs corresponding to respective stunt maneuvers (such as the stunt maneuver models 234). Each of these CMDPs may be trained following a similar process described above to convert a set of expert instructions into an optimized control policy that executes the stunt maneuver. Accordingly, the autonomous vehicle may be configured to automatically execute the stunt maneuvers on demand in response to a stimulus to perform the stunt maneuver.

Autonomous vehicles typically include a perception component (such as the perception component 236) in which one or more of the autonomous vehicle processors analyzes a plurality of sensor data to identify a state of the autonomous vehicle with respect to the environment. For example, the sensor data can include image data, LI DAR data, radar data, accelerometer data, gyroscope data, and so on. The perception component may operate in conjunction with a decision making model, such as the decision making model 232, to process the data and decide on a set of autonomous vehicle controls needed to safely operate the autonomous vehicle. In some scenarios, the decision making model may output the controls signals directly to control the various components of the autonomous vehicle. In other scenarios, the decision making model may invoke another model, such as one of the stunt maneuver CMDPs to derive the set of control signals for a current and/or one or more future states of the autonomous vehicle.

To ensure vehicle safety, the perception component may identify one or more hazards in the vehicle environment. For example, the hazards may include the presence of another vehicle (and/or a current or predicted location thereof), a presence of an object on the road (e.g., vehicle debris), a narrowing of the lane, and/or other conditions which may result in a need to perform an evasive maneuver. As the perception component tracks the hazards, the decision making model may evaluate whether continued operation of the autonomous vehicle in the current manner will be able to avoid the hazard or if the performance of one or more stunt maneuvers is needed to avoid and/or mitigate damage from the hazard. It should be appreciated that the continued operation may be a continued manual operation in a semi-autonomous vehicle embodiment.

As part of evaluating the hazards, the decision making model may begin predicting a likelihood of collision and a capacity of the stunt maneuver CMDPs to avoid and/or mitigate damage therefrom. If the likelihood of collision exceeds a threshold, the decision making model may invoke one or more of the stunt maneuver CMDPs to generate control instructions to mitigate or avoid damage caused by the hazard. In particular, the decision making model may invoke the stunt maneuver CMDP with the highest probability of avoidance. If there are multiple stunt maneuver CMDPs with similar probabilities of avoidance, the decision making model may select the stunt maneuver that exerts the least amount of energy.

On the other hand, if it is determined that a collision cannot be avoided, the decision making model may select the stunt maneuver that results in a least amount of harm. It should be appreciated that different jurisdictions may involve different harm calculations. For example, a first jurisdiction may require the autonomous vehicle prioritize damage to the hazards over damage to the autonomous vehicle, resulting in outcomes where the autonomous vehicle is significantly damaged to avoid harming the hazard. As another example, another jurisdiction may permit damage to hazards to a limited degree resulting in outcomes where both the autonomous vehicle and the hazard experiences minor damage. Accordingly, the decision making model may be configured to operate in compliance with the jurisdictional requirements for different jurisdictions.

Similarly, the decision making model may detect a user input to perform a stunt maneuver. For example, the autonomous vehicle may include a configurable input (such as a button or paddle) that enables the user to indicate that a particular stunt maneuver is to be performed. Accordingly, the decision making model may invoke the stunt maneuver CMDP corresponding to the user-directed stunt maneuver.

Regardless, after determining that a particular stunt maneuver is to be performed, the decision making model may then invoke the CMDP corresponding to that stunt maneuver to perform the stunt maneuver in a safe manner. As described above, if the decision making model is a NMPC, then the decision making model may be able to evaluate the stunt maneuvers and derive the set of control actions approximately in real time. This reduction in processing time may enable the autonomous vehicle to avoid hazards that would otherwise have insufficient time to safely avoid and/or perform stunt maneuvers that involve more uncertainty to be able to perform an evasive action other autonomous vehicle control techniques are unable to safely perform to enable the avoidance of a hazard that was not conventionally possible.

### Example Methods

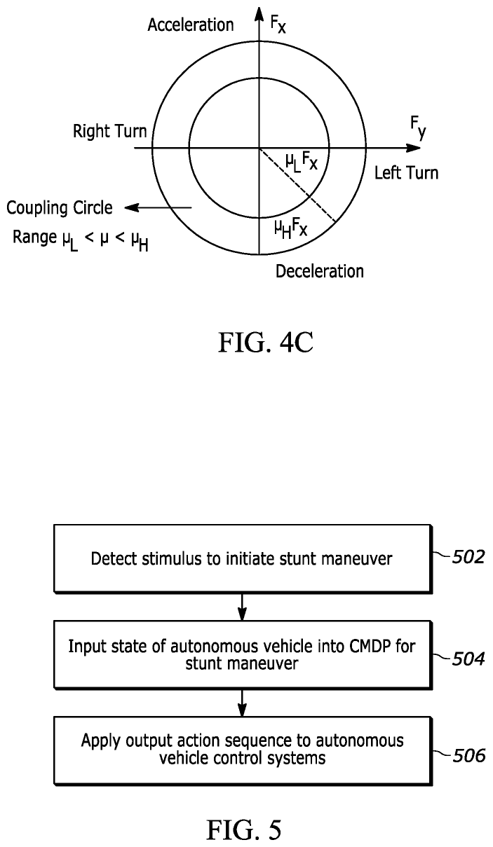

FIG. 5 illustrates an example method 500 for safe stunt maneuver of an autonomous vehicle. For example, the stunt maneuver may be a J-turn maneuver. For example, The method 500 may be performed by one or more processers disposed on an autonomous vehicle, such as the autonomous vehicle 120. For example, the processors may be included in an embedded computing system, such as the embedded computing systems 105, 205 and/or a microcontroller, such as the microcontroller 110.

As described above, the one or more processors may be operatively connected to a constrained Markov decision processing (CMDP) model configured to output an action sequence to control the autonomous vehicle to perform the stunt maneuver. The CMDP is trained by obtaining a set of fuzzy instructions that indicate a set of actions that, when executed by an autonomous vehicle, implement the stunt maneuver. In some embodiments, the set of fuzzy instructions are derived from a set of expert instructions, for example, in the manner described with respect to FIG. 3. The training process may then obtain a dynamic model for the autonomous vehicle. In some embodiments, the dynamic model includes an uncertainty model that represents dynamic forces between tires of the autonomous vehicle and a surface traversed by the autonomous vehicle, such as those described with respect to FIGS. 4A-4C.

The training process may then perform, using the dynamic model, a plurality of simulations of the stunt maneuver using the fuzzy instructions. The CMDP rewards simulations that result in successful performance of the stunt maneuver. More particularly, in some embodiments, the CMDP is configured to reward outputs based upon at least one of an amount of kinetic energy lost while performing the stunt maneuver and an amount of error in autonomous vehicle orientation while performing the stunt maneuver. On the other hand, in some embodiments, the CMDP is configured to assign a discount to simulations where the autonomous vehicle does not remain within a safe zone while performing the stunt maneuver. Regardless, when performing the simulations, the simulation may be configured to use an upper bound of uncertainty in the dynamic model.

The method 500 begins when the one or more processors detect a stimulus to initiate the stunt maneuver (block 502). In some embodiments, to detect the stimulus, the one or processors input data representative of an environment along a direction of travel for the autonomous vehicle into a perception component to identify a hazard. The perception component then provides an indication of the hazard to a decision-making model, such as the decision making model 232, configured to evaluate a predicted capacity for a plurality of stunt maneuvers to avoid the hazard. In these embodiments, the one or more processors may generate the stimulus in response to the decision-making model directing the performance of the stunt maneuver based upon the evaluation.

In some embodiments, the decision-making model may determine that no stunt maneuver in the plurality of stunt maneuvers is able to avoid the hazard. In response, the one or more processors may be configured to evaluate a predicted capacity for the plurality of stunt maneuvers to reduce damage caused by the hazard. As described above, different jurisdictions may involve different damage avoidance requirements. Accordingly, in some embodiments, the decision-making model is trained to evaluate the predicted capacity to reduce damage caused by the hazard based upon a jurisdictional requirement.

At block 504, the one or more processors input a state of the autonomous vehicle into a constrained Markov decision processing (CMDP) model configured to output an action sequence to control the autonomous vehicle to perform the stunt maneuver. To this end, in some embodiments, the one or more processors are configured to analyze data representative of an environment along a direction of travel for the autonomous vehicle to identify a safe zone. The safe zone may then constraint the fuzzy instructions that produce a predicted trajectory of the autonomous vehicle reflected by the output action sequence of the CMDP. In these embodiments, the one or more processors may also input an indication of the safe zone to the CMDP. The safe zone may indicate a width of a road traversed by the autonomous and/or a hazard.

At block 506, the one or more processors, apply the action sequence to autonomous vehicle control systems to cause the autonomous vehicle to perform the stunt maneuver. For example, the action sequence may indicate steering and throttle controls for the autonomous vehicle for one or more states of the autonomous vehicle.

### Additional Consideration

As mentioned above, aspects of the systems and methods described herein are controlled by one or more controllers. The one or more computing systems and/or microcontrollers disclosed herein may be adapted to run a variety of application programs (including the models and perception components described herein), access and store data, including accessing and storing data in the associated databases, and enable one or more interactions as described herein. Typically, the computing system and/or microcontroller disclosed herein is implemented by one or more programmable data processing devices. The hardware elements, operating systems, and programming languages of such devices are conventional in nature, and it is presumed that those skilled in the art are adequately familiar therewith.

The computing systems and/or microcontrollers disclosed herein may also include one or more input/output interfaces for communications with one or more processing systems. Although not shown, one or more such interfaces may enable communications via a network, e.g., to enable sending and receiving instructions electronically. The communication links may be wired or wireless.

The computing systems and/or microcontrollers disclosed herein may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller. For example, the computing systems and/or microcontrollers disclosed herein may include a graphics subsystem to drive the output mechanism. The links of the peripherals to the system may be wired connections or use wireless communications.

Aspects of the systems and methods provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory of such a computer platform. Common forms of computer-readable media therefore include for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM and EPROM, a FLASH-EPROM, any other memory chip or cartridge, or any other medium from which a controller can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

What is claimed is:

1. A computer-implemented method for safe stunt maneuvering of an autonomous vehicle, comprising:
detecting, by one or more processors, a stimulus to initiate a stunt maneuver;
inputting, by the one or more processors, a state of the autonomous vehicle into a constrained Markov decision processing (CMDP) model configured to output an action sequence to control the autonomous vehicle to perform the stunt maneuver, wherein the CMDP model is trained by:
obtaining a set of fuzzy instructions that indicate a set of actions that, when executed by an autonomous vehicle, implement the stunt maneuver,
obtaining a dynamic model for the autonomous vehicle,
performing, using the dynamic model, a plurality of simulations of the stunt maneuver using the fuzzy instructions, wherein the CMDP rewards simulations that result in successful performance of the stunt maneuver; and
applying, by the one or more processors, the action sequence to autonomous vehicle control systems to cause the autonomous vehicle to perform the stunt maneuver.

2. The computer-implemented method of claim 1, wherein the stunt maneuver is a J-turn.

3. The computer-implemented method of claim 1, wherein the set of fuzzy instructions are derived from a set of expert instructions.

4. The computer-implemented method of claim 1, wherein the dynamic model includes an uncertainty model that represents dynamic forces between tires of the autonomous vehicle and a surface traversed by the autonomous vehicle.

5. The computer-implemented method of claim 4, wherein performing the plurality of simulations comprises:
performing, using an upper bound of uncertainty in the dynamic model, the plurality of simulations.

6. The computer-implemented method of claim 1, further comprising:
analyzing, by the one or more processors, data representative of an environment along a direction of travel for the autonomous vehicle to identify a safe zone, wherein the fuzzy instructions constrain a predicted trajectory of the autonomous vehicle reflected by the output action sequence of the CMDP; and
inputting, by the one or more processors, an indication of the safe zone to the CMDP.

7. The computer-implemented method of claim 6, wherein the safe zone is indicative of a width of a road traversed by the autonomous vehicle.

8. The computer-implemented method of claim 6, wherein the safe zone is indicative of hazard.

9. The computer-implemented method of claim 6, wherein the CMDP is configured to assign a discount to simulations where the autonomous vehicle does not remain within the safe zone while performing the stunt maneuver.

10. The computer-implemented method of claim 1, wherein the CMDP is configured to reward outputs based upon at least one of an amount of kinetic energy lost while performing the stunt maneuver and an amount of error in autonomous vehicle orientation while performing the stunt maneuver.

11. The computer-implemented method of claim 1, wherein detecting the stimulus comprises:
inputting, by the one or more processors, data representative of an environment along a direction of travel for the autonomous vehicle into a perception component to identify a hazard, wherein the perception component provides an indication of the hazard to a decision-making model configured to evaluate a predicted capacity for a plurality of stunt maneuvers to avoid the hazard; and
generating, by the one or more processors, the stimulus in response to the decision-making model directing the performance of the stunt maneuver based upon the evaluation.

12. The computer-implemented method of claim 11, wherein the decision-making model is configured such that in response to a determination that no stunt maneuver in the plurality of stunt maneuvers is able to avoid the hazard, the decision-making model is configured to evaluate a predicted capacity for the plurality of stunt maneuvers to reduce damage caused by the hazard.

13. The computer-implemented method of claim 12, wherein decision-making model is trained to evaluate the predicted capacity to reduce damage caused by the hazard based upon a jurisdictional requirement.

14. A non-transitory computer-readable storage medium configured to store processor-executable instructions for safe stunt maneuvering of an autonomous vehicle that, when executed by one or more processors, cause the one or more processors to:
detect a stimulus to initiate a stunt maneuver;
input a state of the autonomous vehicle into a constrained Markov decision processing (CMDP) model configured to output an action sequence to control the autonomous vehicle to perform the stunt maneuver, wherein the CMDP model is trained by:
obtaining a set of fuzzy instructions that indicate a set of actions that, when executed by an autonomous vehicle, implement the stunt maneuver,
obtaining a dynamic model for the autonomous vehicle,
performing, using the dynamic model, a plurality of simulations of the stunt maneuver using the fuzzy instructions, wherein the CMDP rewards simulations that result in successful performance of the stunt maneuver; and
apply the action sequence to autonomous vehicle control systems to cause the autonomous vehicle to perform the stunt maneuver.

15. The non-transitory computer-readable storage medium of claim 14, wherein the dynamic model includes an uncertainty model that represents dynamic forces between tires of the autonomous vehicle and a surface traversed by the autonomous vehicle.

16. The non-transitory computer-readable storage medium of claim 15, wherein performing the plurality of simulations comprises:
performing, using an upper bound of uncertainty in the dynamic model, the plurality of simulations.

17. The non-transitory computer-readable storage medium of claim 14, wherein to detect the stimulus, the instructions, when executed, cause the one or more processors to:
input data representative of an environment along a direction of travel for the autonomous vehicle into a perception component to identify a hazard, wherein the perception component provides an indication of the hazard to a decision-making model configured to evaluate a predicted capacity for a plurality of stunt maneuvers to avoid the hazard; and
generating, by the one or more processors, the stimulus in response to the decision-making model directing the performance of the stunt maneuver based upon the evaluation.

18. The non-transitory computer-readable storage medium of claim 17, wherein the decision-making model is configured such that in response to a determination that no stunt maneuver in the plurality of stunt maneuvers is able to avoid the hazard, the decision-making model is configured to evaluate a predicted capacity for the plurality of stunt maneuvers to reduce damage caused by the hazard.

19. The non-transitory computer-readable storage medium of claim 14, wherein the CMDP is configured to reward outputs based upon at least one of an amount of kinetic energy lost while performing the stunt maneuver and an amount of error in autonomous vehicle orientation while performing the stunt maneuver.

20. The non-transitory computer-readable storage medium of claim 14, wherein the instructions, when executed, cause the one or more processors to:
analyze data representative of an environment along a direction of travel for the autonomous vehicle to identify a safe zone, wherein the fuzzy instructions constrain predicted trajectory of the autonomous vehicle reflected by the output action sequence of the CMDP; and
input an indication of the safe zone to the CMDP.
